(19) United States
(12) Patent Application Publication
(10) Pub. No.: US 2010/0214610 A1
(43) Pub. Date: Aug. 26, 2010

(54) IMAGE FORMING APPARATUS

(76) Inventor: Naoki OTSUKA, Tokyo (JP)

Correspondence Address: Kubotera & Associates, LLC, 200 Daingerfield Rd, Suite 202, Alexandria, VA, 22314, US

(21) Appl. No.: 12/711,526

(22) Filed: Feb. 24, 2010

(30) Foreign Application Priority Data
Feb. 26, 2009 (JP) 2009-043383

(51) Int. Cl. G06F 3/12

(52) U.S. Cl. 358/1.15

(57) ABSTRACT

An image forming apparatus includes a data receiving unit for receiving data containing an object such as a text and a graphic; a data retrieving unit for retrieving specific object data from the data thus received with the data retrieving unit; an output layout configuration rule storage unit for storing an output layout configuration rule specified in advance; an output layout configuration rule selection unit for comparing the object data retrieved with the data retrieving unit with the output layout configuration rule stored in the output layout configuration rule storage unit, and for selecting an output layout template matched; an image creating unit for modifying the data received with the data retrieving unit according to the output layout template selected with the output layout configuration rule selection unit to create a print image; and an image forming unit for printing the print image created with the image creating unit.

### BACKGROUND OF THE INVENTION AND RELATED ART STATEMENT

The present invention relates to an image forming apparatus capable of printing an electric mail received through a communication network.

A conventional image forming apparatus such as an internet facsimile apparatus performs communication through a communication network such as the internet. When the conventional image forming apparatus prints an electric mail (referred to as a mail) received through the communication network, contents of the electric mail are modified according to a standard layout stored in the conventional image forming apparatus before being printed (refer to Patent Reference).

Patent Reference: Japanese Patent Publication No. 2006-14181

As explained above, in the conventional image forming apparatus, the contents of the electric mail are modified according to the standard format stored in the conventional image forming apparatus before being printed. Accordingly, it is difficult to change the format per mail. As a result, when the conventional image forming apparatus receives a mail, it is necessary to print out unnecessary contents of the mail.

In view of the problems described above, an object of the present invention is to provide an image forming apparatus capable of solving the problems.

Further objects and advantages of the invention will be apparent from the following description of the invention.

### SUMMARY OF THE INVENTION

In order to attain the objects described above, according to a first aspect of the present invention, an image forming apparatus includes a data receiving unit for receiving data containing an object such as a text and a graphic; a data retrieving unit for retrieving specific object data from the data thus received with the data retrieving unit; an output layout configuration rule storage unit for storing an output layout configuration rule specified in advance; an output layout configuration rule selection unit for comparing the object data retrieved with the data retrieving unit with the output layout configuration rule stored in the output layout configuration rule storage unit, and for selecting an output layout template matched; an image creating unit for modifying the data received with the data retrieving unit according to the output layout template selected with the output layout configuration rule selection unit to create a print image; and an image forming unit for printing the print image created with the image creating unit.

According to a second aspect of the present invention, an image forming apparatus includes a data receiving unit for receiving data containing an object such as a text and a graphic; a data retrieving unit for retrieving specific object data from the data thus received with the data retrieving unit; an output form configuration rule storage unit for storing an output form configuration rule specified in advance; an output form configuration rule selection unit for comparing the object data retrieved with the data retrieving unit with the output form configuration rule stored in the output form configuration rule storage unit, and for selecting an output form template matched; an image creating unit for modifying the data received with the data retrieving unit according to the output form template selected with the output form configuration rule selection unit to create a print image; and an image forming unit for printing the print image created with the image creating unit.

According to a third aspect of the present invention, the data retrieving unit includes a data analysis section for analyzing the data thus received with the data retrieving unit, and for retrieving information contained in the data as the object, and a data retrieving section for retrieving the specific object data from the object retrieved with the data analysis section.

In the first and second aspects of the present invention, the image forming apparatus is configured to be capable of changing a format of an entire document according to contents of the data thus received. Accordingly, when a receiver receives a mail from a specific sender, it is possible to remove an unnecessary portion of the mail, thereby making it possible to print the data thus received in a simple form.

### BRIEF DESCRIPTION OF THE DRAWINGS

FIG. 1 is a block diagram showing a configuration of an image forming apparatus (such as an internet facsimile apparatus) according to a first embodiment of the present invention;

FIG. 2 is a schematic view showing examples of an output layout template created with an output layout configuration rule creation unit shown in FIG. 1 according to the first embodiment of the present invention;

FIG. 3 is a schematic view showing an example of a table of an output layout configuration rule storage unit shown in FIG. 1 according to the first embodiment of the present invention;

FIG. 4(A) is a flow chart No. 1 showing an operation of the internet facsimile apparatus according to the first embodiment of the present invention;

FIG. 4(B) is a flow chart No. 2 showing the operation of the internet facsimile apparatus when a data retrieving unit shown in FIG. 1 receives a mail according to the first embodiment of the present invention;

FIGS. 5(A) and 5(B) are schematic views showing examples of an object retrieved from a mail according to the first embodiment of the present invention;

FIGS. 6(A) and 6(B) are schematic views showing examples printed with an image forming unit of the internet facsimile apparatus according to the first embodiment of the present invention;

FIGS. 7(A) and 7(B) are schematic views showing examples printed with an image forming unit of a conventional internet facsimile apparatus;

FIG. 8 is a block diagram showing a configuration of an internet facsimile apparatus according to a second embodiment of the present invention;

FIGS. 9(A) and 9(B) are schematic views showing examples of an output form template created with an output form configuration rule creation unit shown in FIG. 8 according to the second embodiment of the present invention;

FIG. 10 is a schematic view showing an example of a table of an output form configuration rule storage unit according to the second embodiment of the present invention;

FIG. 11(A) is a flow chart No. 1 showing an operation of the internet facsimile apparatus shown in FIG. 8 according to the second embodiment of the present invention;

FIG. 11(B) is a flow chart No. 2 showing the operation of the internet facsimile apparatus when a data retrieving unit shown in FIG. 8 receives a mail according to the second embodiment of the present invention;

FIG. 12 is a schematic view showing an example of a mail according to the second embodiment of the present invention;

FIG. 13 is a schematic view showing an example printed with an image forming unit of the internet facsimile apparatus according to the second embodiment of the present invention; and

FIG. 14 is a schematic view showing an example printed with an image forming unit of a conventional internet facsimile apparatus.

### DETAILED DESCRIPTION OF THE PREFERRED EMBODIMENTS

Hereunder, embodiments of the present invention will be explained with reference to the accompanying drawings. The drawings are presented for an explanation purpose only, and the present invention is not limited to the drawings.

### First Embodiment

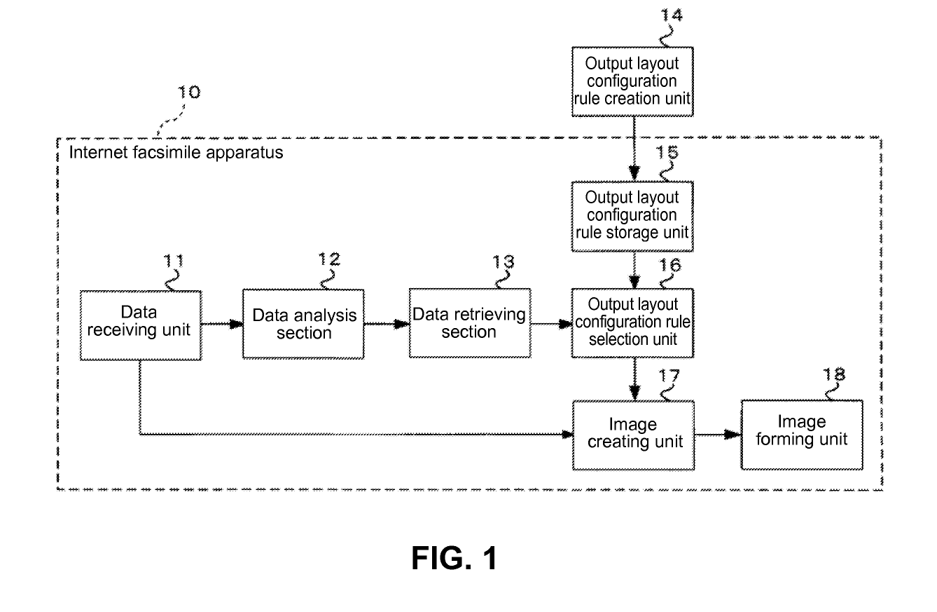

A first embodiment of the present invention will be explained. FIG. 1 is a block diagram showing a configuration of an image forming apparatus (such as an internet facsimile apparatus 10) according to the first embodiment of the present invention.

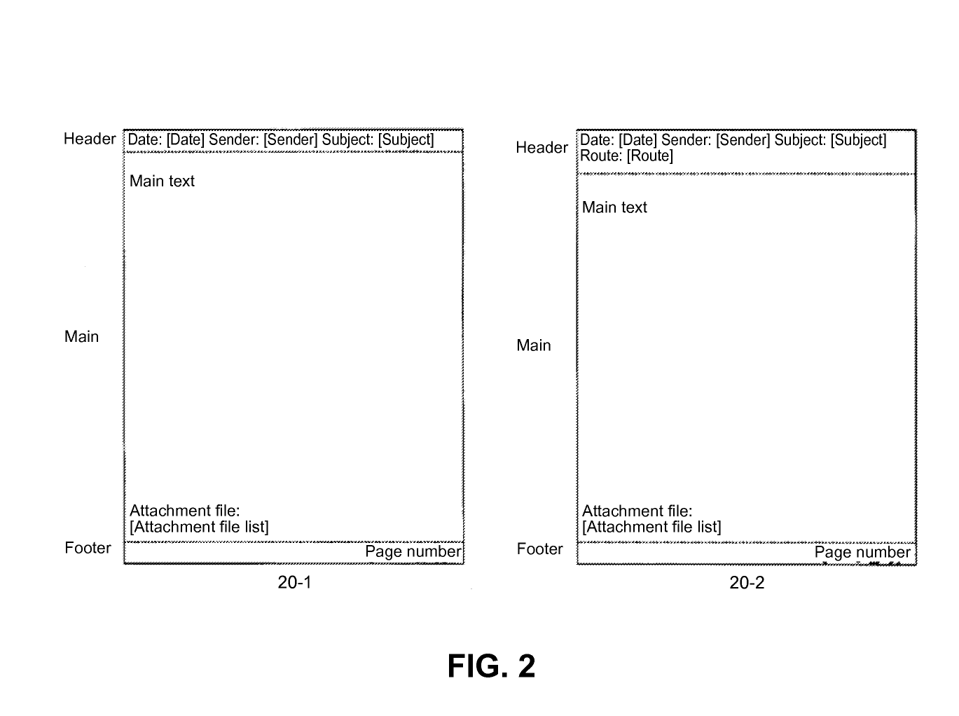

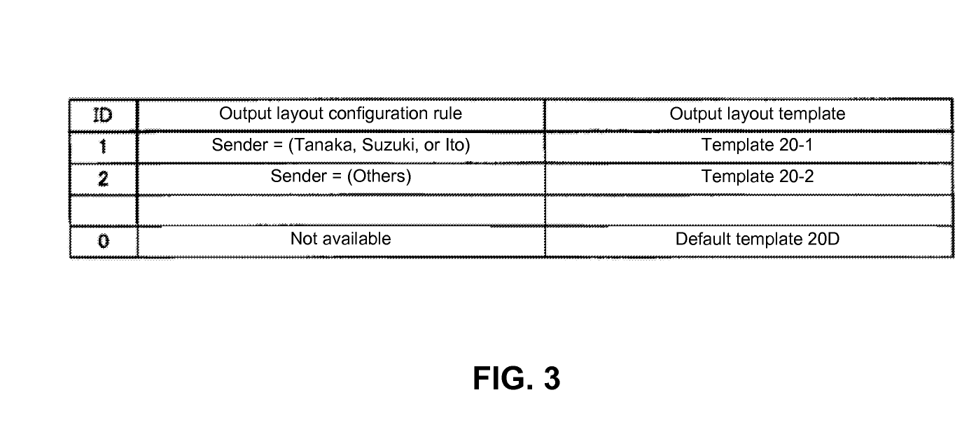

FIG. 2 is a schematic view showing examples of an output layout template 20 created with an output layout configuration rule creation unit 14 shown in FIG. 1 according to the first embodiment of the present invention. FIG. 3 is a schematic view showing an example of a table of an output layout configuration rule storage unit 15 shown in FIG. 1 according to the first embodiment of the present invention.

As shown in FIG. 1, the internet facsimile apparatus 10 includes a data receiving unit 11. The data receiving unit 11 is provided for receiving a mail containing an object such as a text and a graphic from an LAN interface (not shown) provided in the internet facsimile apparatus 10. A data retrieving unit is connected to an output side of the data receiving unit 11. The data retrieving unit is provided for retrieving specific object data from the data received with the data receiving unit 11. The data retrieving unit is formed of a data analysis section 12 and a data retrieving section 13.

In the embodiment, the data analysis section 12 is provided for analyzing a mail received with the data receiving unit 11, and retrieving information contained in the mail as an object. For example, when a mail contains a text string “From:Sender<hoge@hoge.ne.jp>” in a mail header thereof, the data analysis section 12 retrieves a pair of objects “From” and “Sender<hoge@hoge.ne.jp>”. The data retrieving section 13 is connected to an output side of the data analysis section 12.

In the embodiment, the data retrieving section 13 is provided for retrieving necessary object data from the object analyzed with the data analysis section 12 as a key and a value. More specifically, the key includes a route, a sender, a subject, a date, a main text, and an attachment file of the mail, and the value thereof becomes the object data. For example, when the data retrieving section 13 retrieves the object having the key of “From” and the value of “Sender<hoge@hoge.ne.jp>”, the data retrieving section 13 retrieves the object data having the key of “From” and the value of “Sender<hoge@hoge.ne.jp>”.

In the embodiment, the internet facsimile apparatus 10 is connected to the output layout configuration rule creation unit 14. The output layout configuration rule creation unit 14 is formed of, for example, a personal computer having a display unit, a keyboard, a mouse and the like. The output layout configuration rule creation unit 14 has a function of defining the output layout template 20 as a modification model used for printing a mail and a rule (referred to as an output layout configuration rule) of the object contained in the mail for applying the output layout template 20 through application software of the personal computer. Further, the output layout configuration rule creation unit 14 has a function of transmitting the output layout template 20 and the output layout configuration rule to the internet facsimile apparatus 10 with a communication unit on an LAN (Local Area Network, not shown).

As shown in FIGS. 2(A) and 2(B), the output layout template 20 (20-1 and 20-2) defined with the output layout configuration rule creation unit 14 includes three text files divided in, for example, a header, a main portion, and a footer. It is configured that a text string of the key retrieved with the data retrieving section 13 is inserted in a portion between square brackets ([ ]) such as [date], [sender], [subject], [main text], and [attachment file].

In the embodiment, the internet facsimile apparatus 10 includes the output layout configuration rule storage unit 15 connected to an output side of the output layout configuration rule creation unit 14. The output layout configuration rule storage unit 15 is formed of a table storing the output layout template 20 defined with the output layout configuration rule creation unit 14 and the output layout configuration rule for applying the output layout template 20.

FIG. 3 is a schematic view showing an example of the table. As shown in FIG. 3, the table combines the output layout template 20 and the output layout configuration rule as one single record, and an identification ID is automatically assigned to the record.

In the embodiment, an output layout configuration rule selection unit 16 is connected to output sides of the output layout configuration rule storage unit 15 and the data retrieving section 13. The output layout configuration rule selection unit 16 is provided for comparing the object retrieved with the data retrieving unit 13 with the output layout configuration rule stored in the output layout configuration rule storage unit 15, and for selecting the output layout template 20 matched.

When the output layout configuration rule storage unit 15 stores the table shown in FIG. 3 as the example, according to the output layout configuration rule, an output layout template 20-1 is used for the sender with a name “Tanaka”, “Suzuki” or “Ito”, and an output layout template 20-2 is used for other senders. When there is no name as the sender, a default template with the identification ID “0” is used as the output layout template 20. The default template may be stored in advance in the output layout configuration rule storage unit 15.

In the embodiment, an image creating unit 17 is connected to an output side of the output layout configuration rule selection unit 16. The image creating unit 17 is provided for modifying the mail received with the data receiving unit 11 according to the output layout template 20 selected with the output layout configuration rule selection unit 16 to create a print image. More specifically, the image creating unit 17 converts a tag with the key in the output layout template 20 to the object data, thereby creating the print image. An image forming unit 18 is connected to an output side of the image creating unit 17. The mage forming unit 18 is provided for printing the print image created with the image creating unit 17.

An operation of the internet facsimile apparatus 10 will be explained next. The following explanation is divided into a first operation of the internet facsimile apparatus 10 when the output layout configuration rule and the output layout template 20 are created and a second operation of the internet facsimile apparatus 10 when the mail is received.

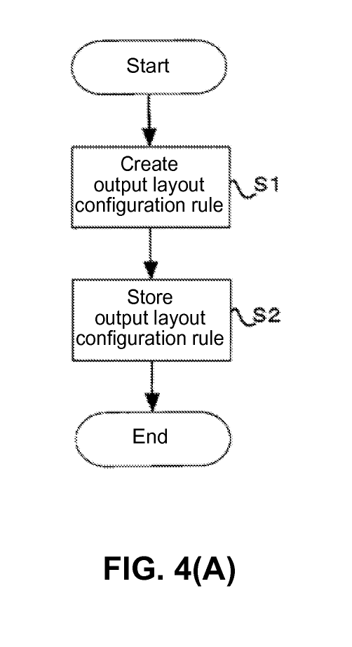

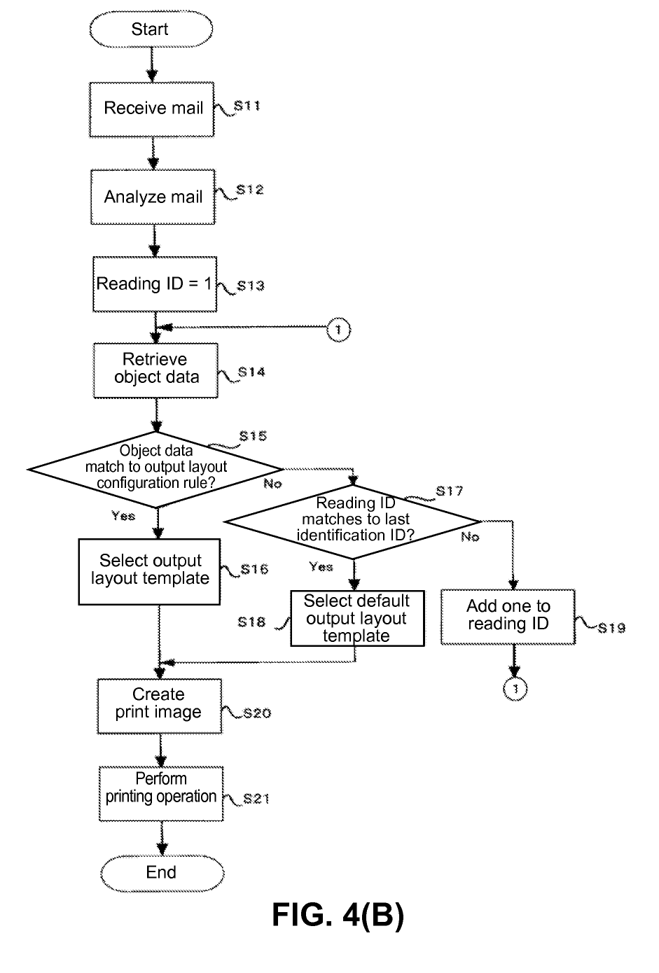

FIG. 4(A) is a flow chart No. 1 showing the first operation of the internet facsimile apparatus 10 when the output layout configuration rule and the output layout template 20 are created according to the first embodiment of the present invention.

In step S1, when the first operation shown in FIG. 4(A) starts (Start), the output layout configuration rule creation unit 14 creates the output layout configuration rule and the output layout template 20. As described above, the examples (20-1 and 20-2) of the output layout template 20 created in step S1 are shown in FIGS. 2(A) and 2(B), and the output layout template 20 is divided into the three portions, i.e., the header, the main portion, and the footer. The output layout template 20 created with the application software is stored in the three text files of the header, the main portion, and the footer. The contents are text strings to be printed.

As described above, it is configured that the text string of the key of the object data is inserted in the portion between the square brackets ([ ]) in the text files, where the object data are desired to insert, such as [date], [sender], [subject], [main text], and [attachment file]. More specifically, in the output layout template 20-1, one line of the received date, the sender, and the subject of the mail is written in the header; the main text and the attachment file list are written in the main portion; and a page number is written in the footer. In the output layout template 20-2, in addition to the output layout template 20-1, the route of the mail is added in the second line of the header.

After step S1 is completed, the process proceeds to step S2. In step S2, the output layout configuration rule and the output layout template 20 created in step S1 are transmitted to the internet facsimile apparatus 10, so that the output layout configuration rule and the output layout template 20 are stored in the output layout configuration rule storage unit 15, thereby completing the process (End).

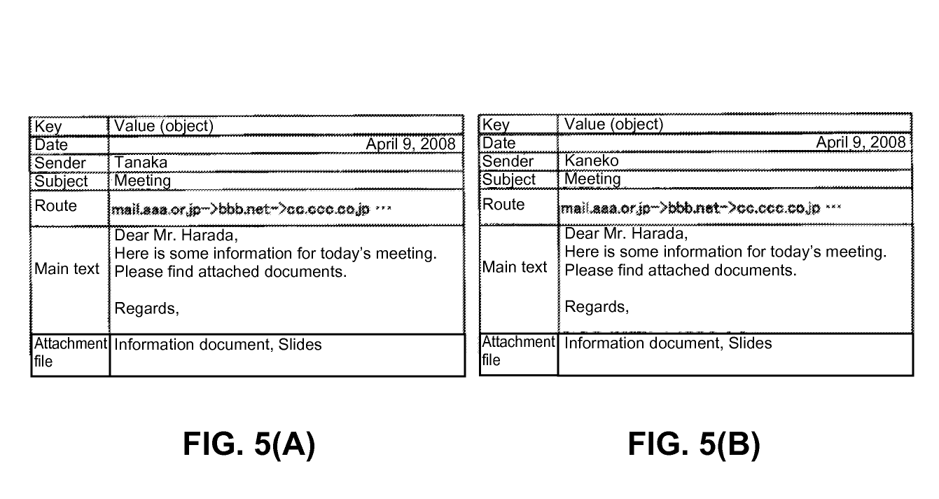

FIG. 4(B) is a flow chart No. 2 showing the second operation of the internet facsimile apparatus 10 when the data receiving unit 11 shown in FIG. 1 receives the mail according to the first embodiment of the present invention. FIGS. 5(A) and 5(B) are schematic views showing examples of the object retrieved from the mail according to the first embodiment of the present invention.

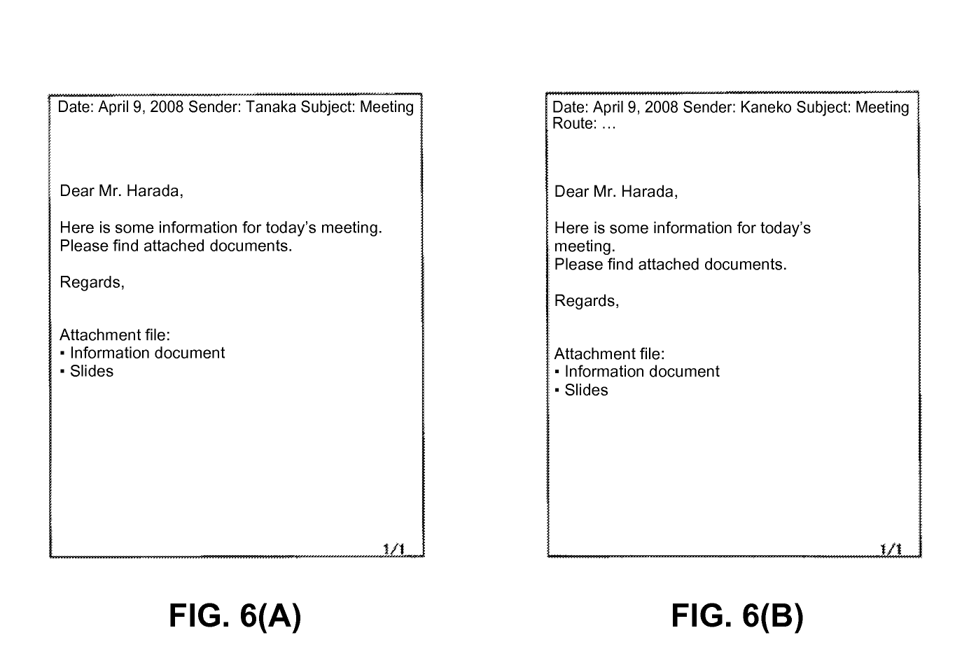

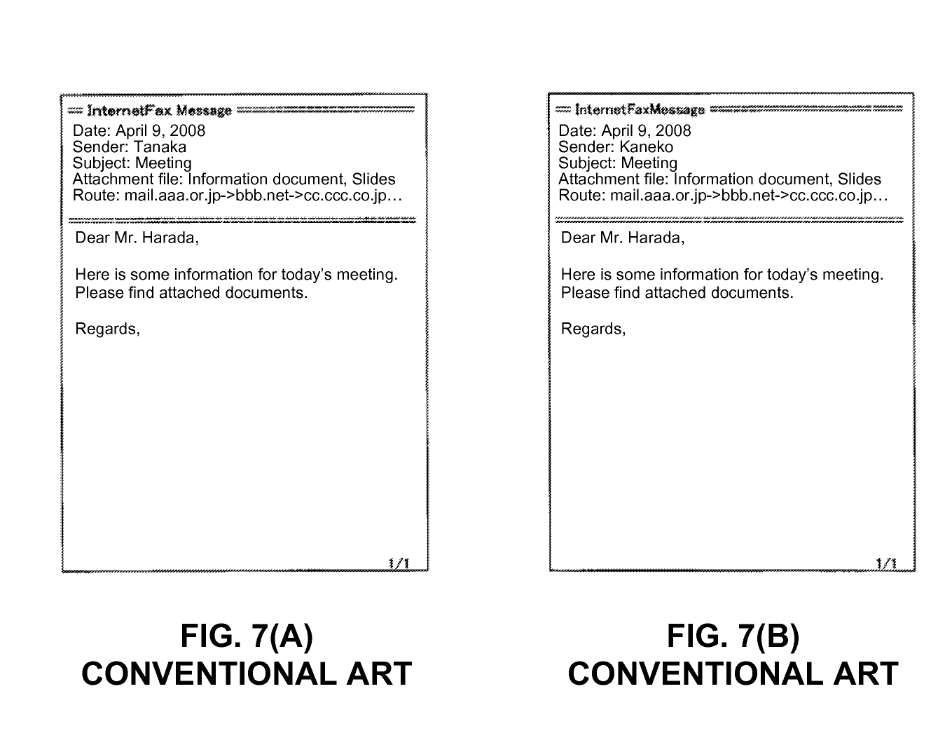

FIGS. 6(A) and 6(B) are schematic views showing examples printed with the image forming unit 18 of the internet facsimile apparatus 10 according to the first embodiment of the present invention. FIGS. 7(A) and 7(B) are schematic views showing examples printed with an image forming unit of a conventional internet facsimile apparatus.

In step S11, when the second operation shown in FIG. 4(B) starts (Start), the data receiving unit 11 receives the mail. In step S12, the data analysis section 12 analyzes the mail thus received, and retrieves the information contained in the mail as the object. In step S13, a reading ID is prepared as a variable, and the reading ID is set to “1” as an initial value. Afterward, the process proceeds to step S14.

In step S14, the data retrieving section 13 selects a specific key such as the route, the sender, the subject, the date, the main text, and the attachment file from the object retrieved in step S12, and retrieves the object data as the value of the specific key. The examples of the object shown in FIGS. 5(A) and 5(B) include the route, the sender, the subject, the date, the main text, and the attachment file retrieved from two mails.

In step S15, the output layout configuration rule selection unit 16 compares the object data retrieved in step S14 with the output layout configuration rule of a record with the identification ID matched to the reading ID in the table in the output layout configuration rule storage unit 15, thereby determining whether the object data match to the output layout configuration rule. When the object data match to the output layout configuration rule (Yes), the process proceeds to step S16. When the object data do not match to the output layout configuration rule (No), the process proceeds to step S17.

For example, when the table shown in FIG. 3 is stored in the output layout configuration rule storage unit 15, the object data shown in FIGS. 5(A) and 5(B) are retrieved in step S14. In the example shown in FIG. 5(A), the sender is listed as “Tanaka”, and the object data match to the output layout configuration rule with the identification ID “1” in FIG. 3. In the example shown in FIG. 5(B), the sender is listed as “Kaneko”, and the object data match to the output layout configuration rule with the identification ID “2” in FIG. 3.

In step S16, the output layout configuration rule selection unit 16 selects the output layout template 20 corresponding to the record with the identification ID matching to the reading ID according to the table in the output layout configuration rule storage unit 15. More specifically, according to the examples described in step S15, in the example shown in FIG. 5(A), the output layout template 20-1 is selected as the output layout template 20, and in the example shown in FIG. 5(B), the output layout template 20-2 is selected as the output layout template 20.

In step S17, the output layout configuration rule selection unit 16 determines whether the value of the reading ID matches to a last identification ID stored in the table in the output layout configuration rule storage unit 15. When the output layout configuration rule selection unit 16 determines that the value of the reading ID matches to the last identification ID (Yes), the process proceeds to step S18. When the output layout configuration rule selection unit 16 determines that the value of the reading ID does not match to the last identification ID (No), the process proceeds to step S19.

In step S18, the output layout configuration rule selection unit 16 selects the default output layout template with the identification ID “0” stored in advance in the output layout configuration rule storage unit 15 as the output layout template 20. In step S19, the output layout configuration rule selection unit 16 adds one to the reading ID.

In step S20, the image creating unit 17 modifies the mail received in step S11 using the output layout template 20 selected in step S16 or step S18, thereby creating the print image. In step S21, the image forming unit 18 performs the printing operation using the print image created in step S20, thereby completing the process (End). In the example shown in FIG. 6(A), the output layout configuration rule shown in FIG. 3 is applied to the object data shown in FIG. 5(A). In the example shown in FIG. 6(B), the output layout configuration rule shown in FIG. 3 is applied to the object data shown in FIG. 5(B).

As a comparison, the schematic views shown in FIGS. 7(A) and 7(B) show the examples printed with the image forming unit of the conventional internet facsimile apparatus. As apparent from the comparison with the conventional internet facsimile apparatus, in the embodiment, it is possible to change the mail format according to the mail thus received. As shown in FIG. 6(A), when the mail is sent from the specific sender, the date, the sender, and the subject are printed in one line, so that a print area of the main text is enlarged. As shown in FIG. 6(B), when the mail is sent from the unregistered sender, the route of the mail is printed.

As described above, in the embodiment, the internet facsimile apparatus 10 includes the output layout configuration rule creation unit 14, the output layout configuration rule storage unit 15, and the output layout configuration rule selection unit 16. Accordingly, it is possible to change the mail format according to the mail thus received. As a result, it is possible to eliminate a portion unnecessary to a receiver when the specific sender sends the mail, thereby making it possible to print the mail in the simple format.

### Second Embodiment

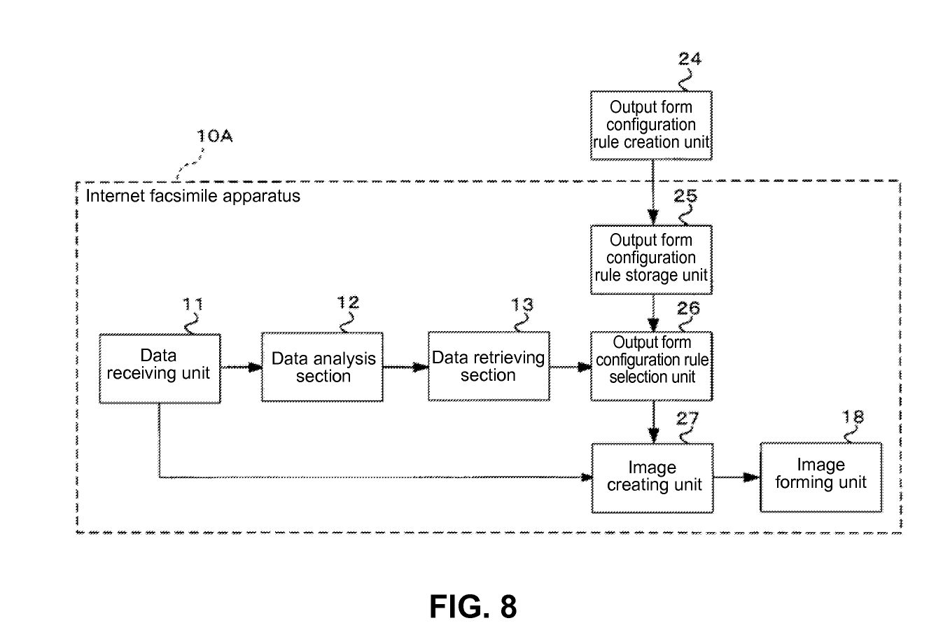

A second embodiment of the present invention will be explained. FIG. 8 is a block diagram showing a configuration of an internet facsimile apparatus 10A according to the second embodiment of the present invention. In the following description, components in the second embodiment similar to those in the first embodiment are designated with the same reference numerals.

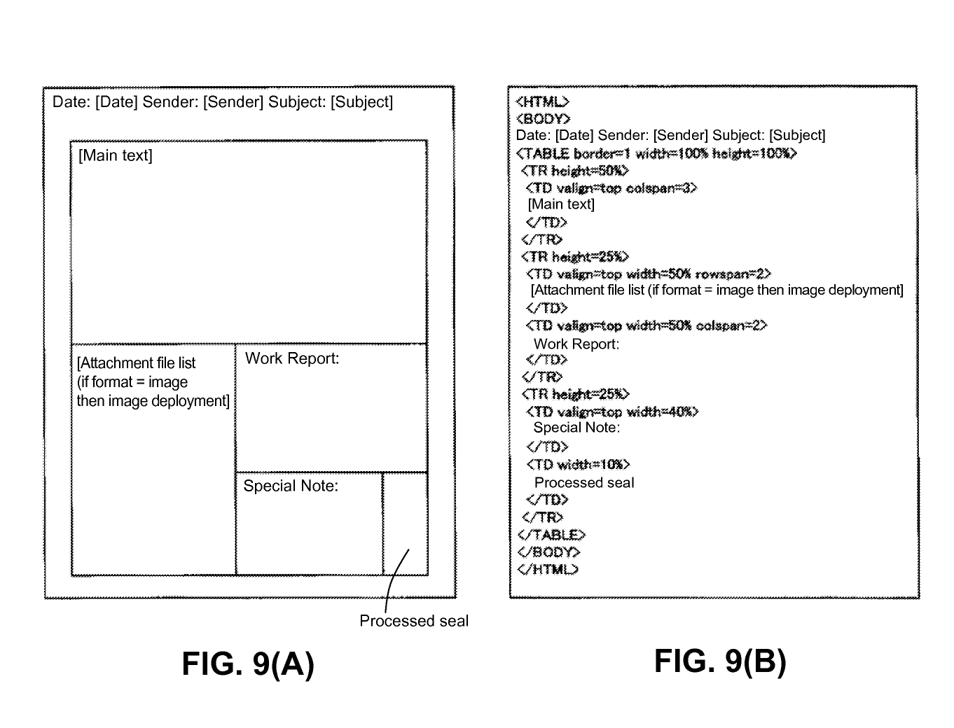

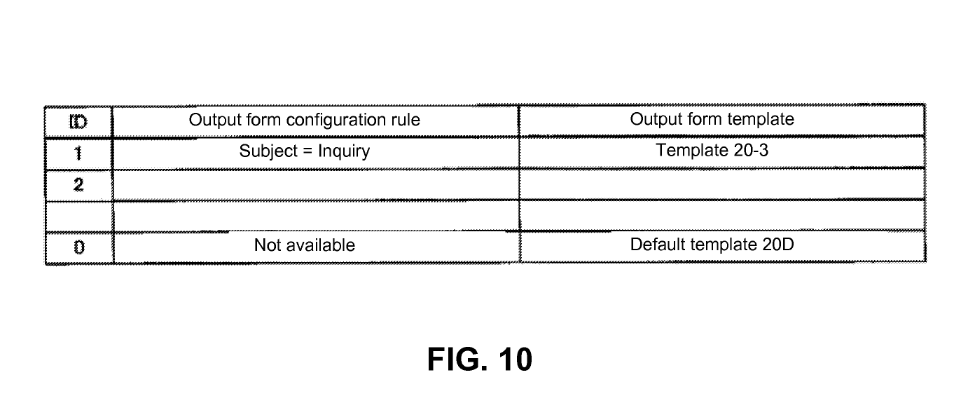

FIGS. 9(A) and 9(B) are schematic views showing examples of an output form template created with an output form configuration rule creation unit 24 shown in FIG. 8 according to the second embodiment of the present invention. FIG. 10 is a schematic view showing an example of a table of an output form configuration rule storage unit 25 according to the second embodiment of the present invention.

In the second embodiment, the output form configuration rule creation unit 24 has a configuration and a function different from those of the output layout configuration rule creation unit 14 in the first embodiment. As shown in FIG. 8, instead of the output layout configuration rule storage unit 15, the output layout configuration rule selection unit 16, and the image creating unit 17 in the first embodiment, the internet facsimile apparatus 10A includes the output form configuration rule storage unit 25; an output form configuration rule selection unit 26; and an image creating unit 27.

In the embodiment, the output form configuration rule creation unit 24 is provided for defining an output form template 20-3 as a modification model used for printing a mail and a rule (referred to as an output form configuration rule) of an object contained in a mail for applying the output form template 20-3 through application software on a personal computer having a display unit, a keyboard, a mouse and the like. Further, the output form configuration rule creation unit 24 has a function of transmitting the output form template 20-3 and the output form configuration rule to the internet facsimile apparatus 10A with a communication unit on an LAN (not shown).

As shown in FIGS. 9(A) and 9(B), the output form template 20-3 is formed of one file written in an HTML (Hyper Text Markup Language) format. It is configured that a text string of a key of the object data is inserted in a portion between square brackets ([ ]) such as [date], [sender], [subject], [main text], and [attachment file] in the HTML file.

In the embodiment, the output form configuration rule storage unit 25 is provided in the internet facsimile apparatus 10A, and is formed of a table storing the output form template 20-3 defined with the output form configuration rule creation unit 24 and the output form configuration rule for applying the output form template 20-3. The output form configuration rule selection unit 26 is connected to an output side of the output form configuration rule storage unit 25.

FIG. 10 is a schematic view showing an example of the table in the output form configuration rule storage unit 25. As shown in FIG. 10, the table combines the output form template 20-3 and the output form configuration rule as one single record, and an identification ID is automatically assigned to the record.

In the embodiment, the output form configuration rule selection unit 26 is provided for comparing the object retrieved with the data retrieving unit 13 with the output form configuration rule stored in the output form configuration rule storage unit 25, and for selecting the output form template matched.

When the output form configuration rule storage unit 25 stores the table shown in FIG. 10 as the example, according to the output form configuration rule, the output form template 20-3 is used when the subject is “Inquiry”. When there is no output form configuration rule, the default output form template 20D with the identification ID “0” is used as the output form template. The default output form template 20D may be stored in the output form configuration rule storage unit 25 in advance.

In the embodiment, the image creating unit 27 is connected to an output side of the output form configuration rule selection unit 26. The image creating unit 27 is provided for modifying the mail received with the data receiving unit 11 according to the output form template 20-3 selected with the output form configuration rule selection unit 26 to create a print image. The image forming unit 18 is connected to an output side of the image creating unit 17 similarly to the first embodiment. The mage forming unit 18 is provided for printing the print image created with the image creating unit 27. Other configurations in the second embodiment are similar to those in the first embodiment.

An operation of the internet facsimile apparatus 10A will be explained next. The following explanation is divided into a first operation of the internet facsimile apparatus 10A when the output form configuration rule and the output form template 20-3 are created and a second operation of the internet facsimile apparatus 10A when the mail is received.

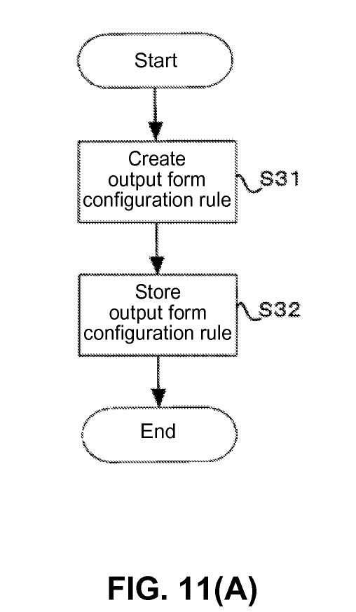

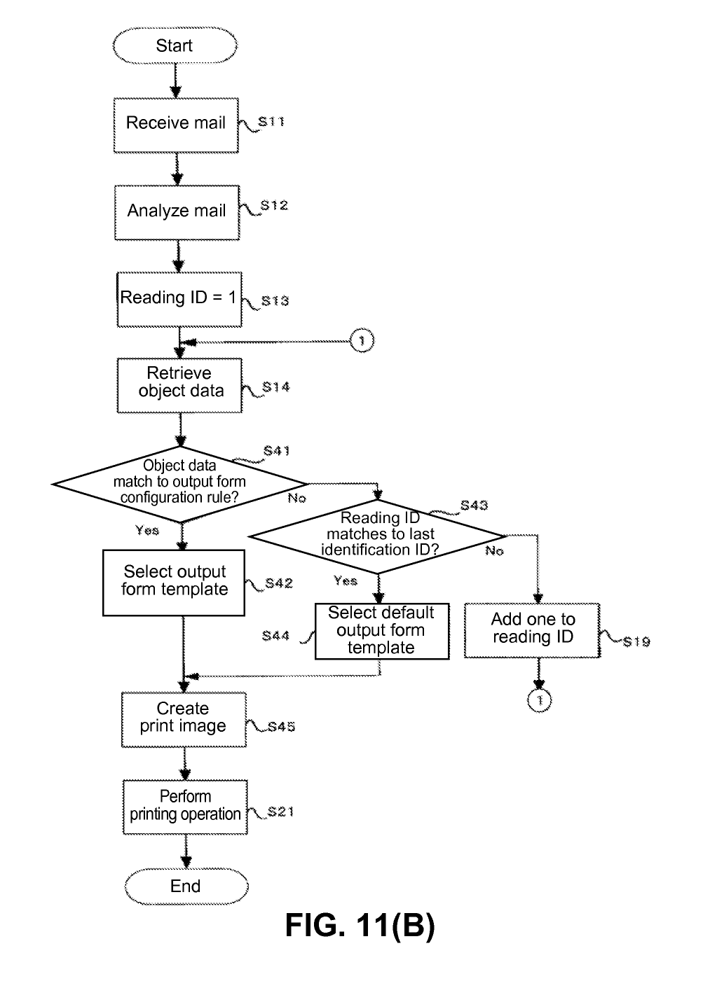

FIG. 11(A) is a flow chart No. 1 showing the first operation of the internet facsimile apparatus 10A when the output form configuration rule and the output form template 20-3 are created according to the second embodiment of the present invention.

In step S31, when the first operation shown in FIG. 11(A) starts (Start), the output form configuration rule creation unit 24 creates the output form configuration rule and the output form template 20-3. As described above, the examples of the output form template 20-3 created in step S31 are shown in FIGS. 9(A) and 9(B). More specifically, FIG. 9(A) is a view showing a layout preview (an image) of the output form template 20-3, and FIG. 9(B) is a view showing the output form template 20-3 created through conversion with the application software.

In the embodiment, the contents of the output form template 20-3 shown in FIG. 9(B) are described in the HTML format. It is configured that the text string of the key of the object data is inserted in the portion between the square brackets ([ ]) in the text file, where the object data are desired to insert, such as [date], [sender], [subject], [main text], and [attachment file].

As shown in FIG. 9(A), “if format=image then image deployment” is written in an attachment file list. Accordingly, when the attachment file is an image file, the attachment file is deployed as an image when the image creating unit 27 creates the print image. The output form template 20-3 is divided into the main text and the attachment file list with lines, and further has spaces such as a work report, a special note, and a processed seal, thereby making it possible to write in the spaces if necessary after the printing operation.

In step S32, the output form configuration rule and the output form template 20-3 created in step S31 are transmitted to the internet facsimile apparatus 10A, so that the output form configuration rule and the output form template 20-3 are stored in the output form configuration rule storage unit 25, thereby completing the process (End).

FIG. 11(B) is a flow chart No. 2 showing the second operation of the internet facsimile apparatus 10A when the data receiving unit 11 shown in FIG. 8 receives the mail according to the second embodiment of the present invention. Components described below similar to those shown in FIG. 4(B) in the first embodiment are designated with the same reference numerals.

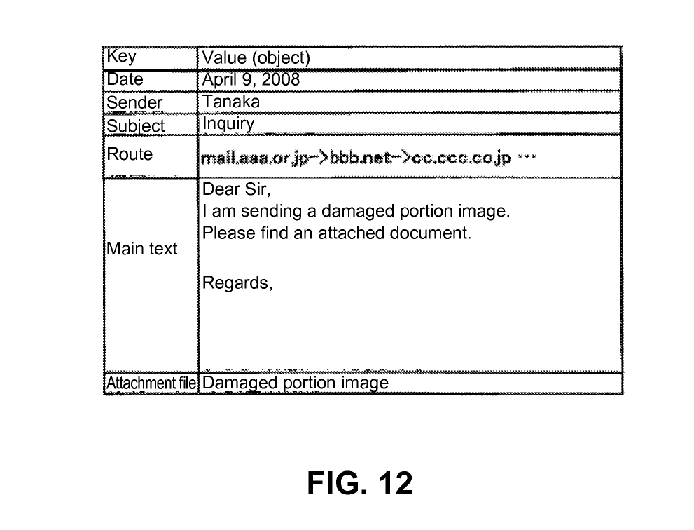

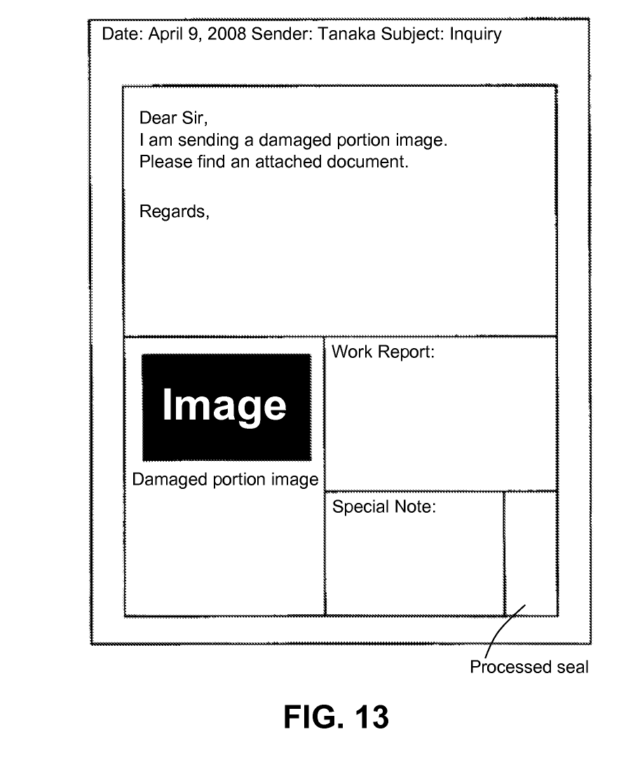

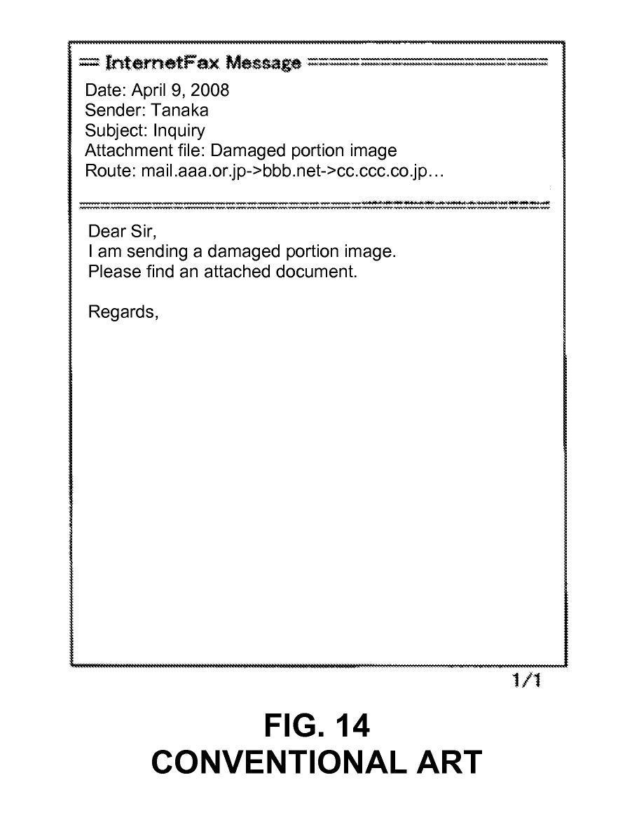

FIG. 12 is a schematic view showing an example of the mail according to the second embodiment of the present invention. FIG. 13 is a schematic view showing an example printed with the image forming unit 11 of the internet facsimile apparatus 10A according to the second embodiment of the present invention. FIG. 14 is a schematic view showing an example printed with an image forming unit of a conventional internet facsimile apparatus.

In the flow chart shown in FIG. 11(B), instead of steps S15 to S18 and S20 in the first embodiment, steps S41 to S45 are performed. When the second operation shown in FIG. 11(B) starts (Start), the process similar to that from steps 11 to S14 in the first embodiment is performed. Then, the process proceeds to step S41.

In step S41, the output form configuration rule selection unit 26 compares the object data retrieved in step S14 with the output form configuration rule of a record with the identification ID matched to the reading ID in the table in the output form configuration rule storage unit 25, thereby determining whether the object data match to the output form configuration rule. When the object data match to the output form configuration rule (Yes), the process proceeds to step S42. When the object data do not match to the output form configuration rule (No), the process proceeds to step S43.

For example, when the table shown in FIG. 10 is stored in the output form configuration rule storage unit 25, the object data such as the date, the sender, the subject, the route, the main text, and the attachment file of the mail received in step S11 are retrieved in step S14. In the example shown in FIG. 12, the subject is listed as “Inquiry”, and the object data match to the output form configuration rule with the identification ID “1” in FIG. 10.

In step S42, the output form configuration rule selection unit 26 selects the output form template corresponding to the record with the identification ID matching to the reading ID according to the table in the output form configuration rule storage unit 25. In the example shown in FIG. 12, the subject is listed as “Inquiry”, and matches to the output form configuration rule with the identification ID “1” in FIG. 10. Accordingly, the output form template 20-3 is selected as the output form template.

In step S43, the output form configuration rule selection unit 26 determines whether the value of the reading ID matches to a last identification ID stored in the table in the output form configuration rule storage unit 25. When the output form configuration rule selection unit 26 determines that the value of the reading ID matches to the last identification ID (Yes), the process proceeds to step S44. When the output form configuration rule selection unit 26 determines that the value of the reading ID does not match to the last identification ID (No), the process proceeds to step S19 similar to the first embodiment.

In step S44, the output form configuration rule selection unit 26 selects the default output form template with the identification ID “0” stored in advance in the output layout configuration rule storage unit 15 as the output layout template 20. In step S45, the image creating unit 27 modifies the mail received in step S11 using the output form template selected in step S42 or step S44, thereby creating the print image. Afterward, similar to the first embodiment, in step S21, the image forming unit 18 performs the printing operation using the print image created in step S45, thereby completing the process (End).

FIG. 13 is the schematic view showing the example printed in step S21. As shown in FIG. 13, the output form configuration rule shown in FIG. 10 is applied to the object data shown in FIG. 12, and the output form template 20-3 shown in FIG. 9(A) is adapted to the printed result. The view shown in FIG. 13 is updated per image thus received.

As a comparison, the schematic view shown in FIG. 14 shows the example printed with the image forming unit of the conventional internet facsimile apparatus. As apparent from the comparison with the conventional internet facsimile apparatus, in the embodiment, it is possible to change the mail format according to the mail thus received. As shown in FIG. 13, when the subject is listed as “Inquiry”, the mail is divided into the main text and the attachment file with the lines, so that the spaces are secured for writing in if necessary after the printing operation.

As described above, in the second embodiment, the internet facsimile apparatus 10A includes the output form configuration rule creation unit 24, the output form configuration rule storage unit 25, and the output form configuration rule selection unit 26. Accordingly, it is possible to change the mail format of the entire portion of the mail according to the contents of the mail thus received. Further, the output form template is described in the HTML format. As a result, in addition to the effect in the first embodiment, it is possible to secure the spaces for writing in if necessary after the printing operation.

The present invention is not limited to the embodiments described above, and may be modified in various ways as follows.

In the first embodiment, the output layout configuration rule creation unit 14 is formed of the personal computer having the display unit, the keyboard, the mouse and the like. Alternatively, an operation panel unit having a display unit, a key input unit, and the like may be mounted on the internet facsimile apparatus 10. Further, a web server may be disposed in the internet facsimile apparatus 10, so that a web browser is running on the PC to access to the internet facsimile apparatus 10, thereby creating the output layout configuration rule. The web server is a server computer on which a service program and a service thereof are operated for providing a display of an object such as HTML, an image, and the like with respect to the web browser of client software according to HTTP. The web browser is application software for displaying a web page on the world-wide-web (WWW) while browsing links of hyper texts.

In the first embodiment and the second embodiment, the internet facsimile apparatus 10 and the internet facsimile apparatus 10A are explained in the case of receiving the mail. Alternatively, the present invention is not limited to the mail reception, and may be applicable to generic data as far as the data retrieving section 13 is capable of receiving the data.

In the first embodiment and the second embodiment, the output layout configuration rule selection unit 16 or the output form configuration rule selection unit 26 selects the output layout configuration rule or the output form configuration rule only when the output layout configuration rule or the output form configuration rule matches to the object specified among the data retrieval results. Alternatively, the output layout configuration rule selection unit 16 or the output form configuration rule selection unit 26 may select a complex rule described with a standard language.

In the first embodiment and the second embodiment, the internet facsimile apparatus 10 and the internet facsimile apparatus 10A are explained as the image forming apparatus. Alternatively, the present invention is not limited to the internet facsimile apparatus 10 and the internet facsimile apparatus 10A, and may be applicable to other image forming apparatus having the image forming unit 18 such as a multi function product and the like.

The disclosure of Japanese Patent Application No. 2009-043383, filed on Feb. 26, 2009, is incorporated in the application by the reference.

While the invention has been explained with reference to the specific embodiments of the invention, the explanation is illustrative and the invention is limited only by the appended claims.

What is claimed is:

1. An image forming apparatus, comprising:
a data receiving unit for receiving data containing an object;
a data retrieving unit for retrieving object data from the data;
an output layout configuration rule storage unit for storing an output layout configuration rule;
an output layout configuration rule selection unit for comparing the object data with the output layout configuration rule, and for selecting an output layout template;
an image creating unit for modifying the data according to the output layout template to create a print image; and
an image forming unit for printing the print image.

2. The image forming apparatus according to claim 1, wherein said output layout configuration rule selection unit is arranged to select the output layout template formed of a text file including print area information of a main portion, a header portion, and a footer portion so that the image creating unit inserts a tag into the text file.

3. The image forming apparatus according to claim 1, wherein said output layout configuration rule selection unit is arranged to select a predetermined output layout template when the object data does not match to the output layout configuration rule.

4. The image forming apparatus according to claim 1, wherein said data retrieving unit includes a data analysis section for analyzing the data to retrieve information in the data as the object and a data retrieving section for retrieving the object data from the object.

5. The image forming apparatus according to claim 3, wherein said output layout configuration rule selection unit is arranged to select a default output layout template as the predetermined output layout template.

6. An image forming apparatus, comprising:
a data receiving unit for receiving data containing an object;
a data retrieving unit for retrieving object data from the data;
an output form configuration rule storage unit for storing an output form configuration rule;
an output form configuration rule selection unit for comparing the object data with the output form configuration rule, and for selecting an output form template;
an image creating unit for modifying the data according to the output form template to create a print image; and
an image forming unit for printing the print image.

7. The image forming apparatus according to claim 6, wherein said output form configuration rule selection unit is arranged to select the output form template formed of a file with an HTML format so that the image creating unit inserts a tag into the file.

8. The image forming apparatus according to claim 6, wherein said image creating unit is arranged to deploy an image file according to the output form template to create an image when the data contains the image file.

9. The image forming apparatus according to claim 6, wherein said output form configuration rule selection unit is arranged to select a predetermined output form template when the object data does not match to the output form configuration rule.

10. The image forming apparatus according to claim 6, wherein said data retrieving unit includes a data analysis section for analyzing the data to retrieve information in the data as the object and a data retrieving section for retrieving the object data from the object.

11. The image forming apparatus according to claim 9, wherein said output layout configuration rule selection unit is arranged to select a default output form template as the predetermined output form template.

12. The image forming apparatus according to claim 1, wherein said output layout configuration rule selection unit is arranged to select the output layout template formed of a text file including print area information of a main portion, a header portion, and a footer portion, said receiving unit receiving a mail as the data, said image creating unit replacing the main portion with a main text of the mail and the footer portion with the object.

13. The image forming apparatus according to claim 1, wherein said data receiving unit is arranged to receive the data containing the object including a date of a mail, a sender of the mail, a title of the mail, and route information of the mail, said output layout configuration rule selection unit selecting the output layout template including the header portion having a date portion, a sender portion, a title portion, and a route information portion, said output layout configuration rule selection unit selecting the output layout template including the footer portion having a page number portion, said image creating unit replacing the main portion with a main text of the mail, replacing the date portion with the date, replacing the sender portion with the sender, replacing the title portion with the title, replacing the route information portion with the route information, and replacing the page number portion with a number of the mail.
